(19) United States
(12) Patent Application Publication
(10) Pub. No.: US 2015/0120800 A1
(43) Pub. Date: Apr. 30, 2015

(54) CONTEXTUAL CONTENT TRANSLATION SYSTEM

(71) Applicants: Mark D. Yarvis, Portland, OR (US); Joshua Boelter, Portland, OR (US); Sharad K. Garg, Portland, OR (US); Hong Li, El Dorado Hills, CA (US)

(72) Inventors: Mark D. Yarvis, Portland, OR (US); Joshua Boelter, Portland, OR (US); Sharad K. Garg, Portland, OR (US); Hong Li, El Dorado Hills, CA (US)

(21) Appl. No.: 14/128,156

(22) PCT Filed: Oct. 31, 2013
(86) PCT No.: PCT/US13/67797

§ 371 Date: Dec. 20, 2013

(51) Int. Cl. H04L 29/08

(52) U.S. Cl. CPC H04L 67/10; H04L 67/02
USPC 709/201

(57) ABSTRACT

The present disclosure is directed to contextual content translation system. A system may comprise a device to present content to a user, the content being obtained from a content provider (CS). Prior to presentation, a contextual translation (CT) module may augment the content based on the context of the user. The CT module may receive the content from the CS, may receive information about the context of the user from a user data (UD) module and may augment the content based on the user context. Additional information may be provided by a relationship builder (RB) module, as needed, to help determine the correspondence between the content and the user context. Augmenting the content may comprise altering the content (e.g., changing or removing portions of the content) or adding information to the content, the information relating to how portions of the content may correspond to the context of the user.

### TECHNICAL FIELD

The present disclosure relates to data presentation, and more particularly, to a system for presenting content based on a context corresponding to a user viewing the presentation.

### BACKGROUND

The evolution of electronic communication has perpetuated an increase in the amount of content consumed online. For example, textual electronic content is replacing periodicals, books, etc. typically enjoyed in paper form. Movies, television shows, music, special events, etc. may be streamed on-demand, replacing theatres, television and radio as the usual sources for this type of content. Even physical navigation tools such as maps are now being usurped by voice-prompted navigation. Moreover, this movement towards total electronic immersion is occurring on a global basis, which as a result has increased the exposure of individual users to previously unknown sources of information. For example, users now have ready access to news sources not located in their region, which may offer perspectives not being presented by their local reporters. In addition, the increasing ease in making content available online has allowed more content providers to directly access more potential content consumers, which has allowed users to discover new topics of interest regionally, nationally and internationally.

The ability to access information from anywhere in the world has been simplified to a simple click-and-consume operation. However, the instant delivery of global content may be accompanied by complications. Content may be obtained from regions with characteristics that are substantially different from those of the consuming user. For example, content may be obtained from a region in a different time zone, having a foreign language (e.g., including unknown dialect, slang, colloquialisms, etc.), with different customs, measures, etc. At first glance a user's unfamiliarity with these differences may contribute to a hesitation to consume content that may otherwise be beneficial. However, this trepidation may be unwarranted as the user may actually be able to readily comprehend the content when considered in terms of his/her context including, for example, the user's background, living situation, relationships, etc. As a result, a user may miss out on content they might enjoy due to contextual barriers.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example contextual content translation system in accordance with at least one embodiment of the present disclosure;

FIG. 2 illustrates an example configuration wherein a device performs contextual translation in accordance with at least one embodiment of the present disclosure;

FIG. 3 illustrates an example configuration wherein a content provider performs contextual translation in accordance with at least one embodiment of the present disclosure;

FIG. 4 illustrates an example configuration wherein a third party performs contextual translation in accordance with at least one embodiment of the present disclosure;

FIG. 5 illustrates an example configuration for a contextual content translation module in accordance with at least one embodiment of the present disclosure;

FIG. 6 illustrates a first example of contextual content translation in accordance with at least one embodiment of the present disclosure;

FIG. 7 illustrates a second example of contextual content translation in accordance with at least one embodiment of the present disclosure;

FIG. 8 illustrates a third example of contextual content translation in accordance with at least one embodiment of the present disclosure; and

FIG. 9 illustrates example operations for a contextual content translation system in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

The present disclosure is directed to contextual content translation system. A system may comprise, for example, a device to present content to a user, the content being obtained from a content provider (CP). Prior to presentation, a contextual translation (CT) module may augment the content based on the context of the user. The CT module may be in the device, provided by the content provider or a third party, etc. For example, the CT module may receive the content from the CP, may receive information about the context of the user from a user data (UD) module and may then augment the content based on the user context. Additional information may be provided by a relationship builder (RB) module, as needed, to help determine the correspondence between the content and the context corresponding to the user. In one embodiment, the CT module may comprise at least one content augmentation (CA) module to detect a characteristic of the content, determine a correspondence between the content and the context corresponding to the user and augment the content based on the correspondence. Augmenting the content may comprise, for example, altering the content (e.g., changing or removing portions of the content) or adding information to the content, the information relating to how portions of the content may correspond to the context of the user.

In one embodiment, a device may comprise at least a communication module and a user interface module. The communication module may be to transmit and receive data. The user interface module may be to cause content to be requested from a content provider via the communication module, receive augmented content from a CT module, the CT module being to augment the content provided by the content provider based on a context corresponding to a device user, and present the augmented content. Consistent with embodiments of the present disclosure, the CT module may be situated in the device, provided by the content provider or provided by a third party interacting with at least one of the device or the content provider.

The CT module may further be to receive the context corresponding to the device user from a user data module. For example, the context corresponding to the device user may be derived at least in part from social media information associated with the device user. The context corresponding to the device user may also be derived at least in part from information provided by sensors in the device. The UD module may be situated in the device. Alternatively, the UD module may be situated remotely from the device and is accessible via the communication module.

The CT module may comprise, for example, an RB module to at least obtain additional information for determining correspondence between information in the content and the context corresponding to the device user. The CT module may further comprise at least one CA module to detect at least one characteristic of the content, determine a correspondence between the at least one characteristic in the content and at least one characteristic in the context corresponding to the device user and augment the content based on the correspondence. In one embodiment, the CT module may comprise a plurality of CA modules to detect different characteristics of the content. The CT module being to augment the content may comprise the CT module being to at least one of alter the content based on the correspondence, remove a portion of the content based on the correspondence or add information regarding the correspondence to the content. A method consistent with the present disclosure may comprise, for example, triggering in a device a requirement for content provided by a content provider, receiving augmented content from a contextual translation module, the contextual translation module being to augment the content provided by the content provider based on a context corresponding to a device user and presenting the augmented content.

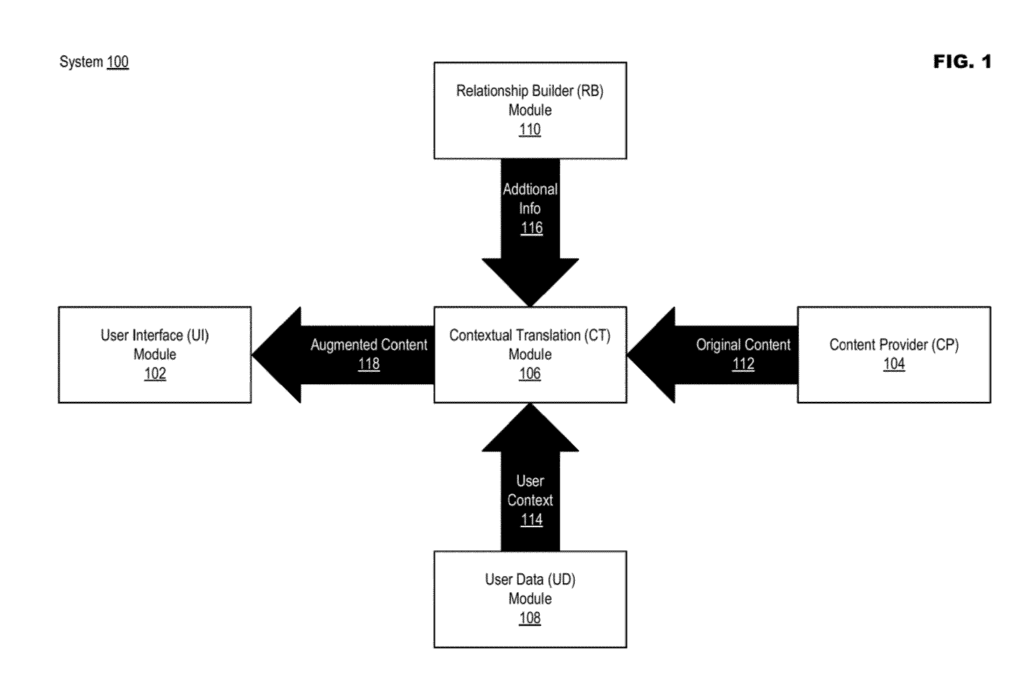

FIG. 1 illustrates an example contextual content translation system in accordance with at least one embodiment of the present disclosure. System 100 may comprise, for example, UI module 102, CP 104, CT module 106, UD module 108 and RB module 110. UI module 102 may comprise equipment and/or software in a device that allows a user of the device to request, obtain and consume content (e.g., view the content, listen to the content, experience haptic feedback based on the content, etc.). For example, user interface module 102 may be incorporated within a device such as, but are not limited to, a mobile communication device such as a cellular handset or a smartphone based on the Android® OS, iOS®, Windows® OS, Blackberry® OS, Palm® OS, Symbian® OS, etc., a mobile computing device such as a tablet computer like an iPad®, Surface®, Galaxy Tab®, Kindle Fire®, etc., an Ultrabook® including a low-power chipset manufactured by Intel Corporation, a netbook, a typically stationary computing device like a desktop computer, a set-top box, a smart television, etc.

Consistent with the present disclosure, CP 104 may be situated apart from the device comprising at least user UI 102. For example, CP 104 may comprise at least one computing device (e.g., a server) accessible via a local-area network (LAN) and/or a wide-area network (WAN) like the Internet (e.g., organized in a “cloud” computing architecture). CP 104 may provide content comprising text, images, audio, video and/or haptic feedback (e.g., delivered via a single download or continuously via “streaming”) and may be maintained by a content creator and/or another party that may provide content to users for free, on a subscription basis, on an on-demand purchase basis, etc.

In an example of operation, activity occurring in UI module 102 may cause content to be requested from CP 104. For example, user interaction with an application such as, but not limited to, an Internet browser, a specialized text, audio and/or video presentation program, a social media application, etc. may cause a request for content to be transmitted. The request may cause CP 104 to provide original content 112 (e.g., the requested content without any augmentation) to CT module 106. The context of original content 112 may correspond to the context of CP 104, and thus, may include characteristics such as time zone, language, people, places, etc. familiar to the location of CP 104. CT module 106 may augment original content 112 based on the context of the user interacting with user interface module 102. In instances where multiple users may exist (e.g., where a device may be accessed by more than one user), CT module 106 may initially determine the identity of the current user. User identity determination may be carried out by identification resources in UI module 102 including, but not limited to, username/password entry, biometric identification (e.g., face recognition, fingerprint identification, retina scan, etc.), scanning an object identifying the user, etc.

Augmentation, as referenced herein, may comprise changing portions of the content, removing portions of the content, adding information to the content, etc. Augmentation may be performed at least based on user context 114 provided by UD module 108. User context 114 may include data pertaining to the user's background (e.g., personal information, viewpoints, activities, etc.), living situation (e.g., residence, school, workplace, etc.), relationships (e.g., family, friends, school colleagues, business associates, etc.), etc. The information in UD module 108 may be accumulated using a variety of methods. For example, a user may manually input some or all of the context information into UD module 108 (e.g., via UI module 102). Alternatively, some or all of the context in UD module 108 may be accumulated automatically. For example, a user may input some information that forms “seeds” in UD module 108. UD module 108 may then comprise an analytical (e.g., data mining) engine to accumulate further information based on the seeds. For example, contextual information may be accumulated from information stored on device 200 such as email databases, contact lists, etc., from online resources such as social media networks, professional associations, search engines results, etc., from historical or real-time location information provided by a global positioning system (GPS) receiver or network connectivity (e.g., LAN, cellular network, etc.), etc. The accumulated information may be compiled by UD module 108 to form user context 114 corresponding to the user interacting with UI module 102.

In some instances, RB module 110 may be requested to obtain additional information 116 (e.g., by CT module 106) to assist in determining correspondence between the content and user context 114. CT module 106 may receive original content 112, user context 114 and additional information 116 (if required), and may use this information to generate augmented content 118. Augmented content 118 may then be provided to UI module 102 for presentation to the user. For example, augmented content 118 may comprise a version of original content 112 that has been altered to be more relevant to the user based on the context of the user, which may make the content more comprehensible, meaningful, enjoyable, etc. Examples of modifications may comprise, but are not limited to, time zone changes, language translation including dialect, slang, colloquialism redefinition, the addition of indicators with respect to commonality between the content and the context of the user (e.g., commonalities in previously visited locations, interests, relationships, etc.), etc.

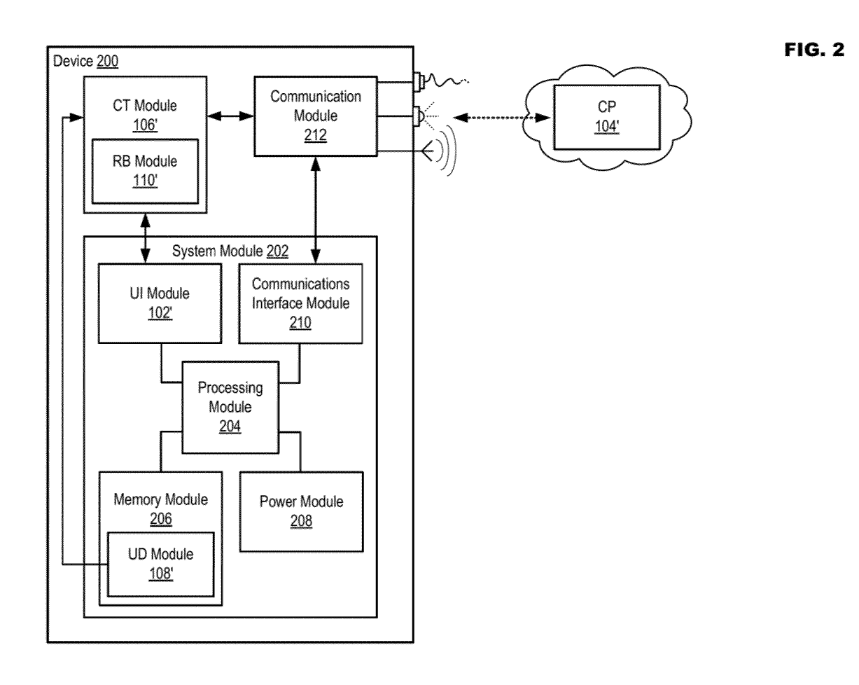

FIG. 2 illustrates an example configuration wherein a device performs contextual translation in accordance with at least one embodiment of the present disclosure. Device 200 may be able to perform example functionality such as disclosed in FIG. 1. However, device 200 is meant only as an example of equipment usable in embodiments consistent with the present disclosure, and is not meant to limit these various embodiments to any particular manner of implementation.

Device 200 may comprise system module 202 configured to manage device operations. System module 202 may include, for example, processing module 204, memory module 206, power module 208. UI module 102′ and communication interface module 210. Device 200 may also include communication module 212 and CT module 106′. While communication module 212 and CT module 106′ have been illustrated separately from system module 202, the example implementation of device 200 has been provided merely for the sake of explanation. Some or all of the functionality associated with communication module 212 and/or CT module 106′ may also be incorporated within system module 202.

In device 200, processing module 204 may comprise one or more processors situated in separate components, or alternatively, may comprise one or more processing cores embodied in a single component (e.g., in a System-on-a-Chip (SOC) configuration) and any processor-related support circuitry (e.g., bridging interfaces, etc.). Example processors may include, but are not limited to, various x86-based microprocessors available from the Intel Corporation including those in the Pentium, Xeon, Itanium, Celeron, Atom, Core i-series product families, Advanced RISC (e.g., Reduced Instruction Set Computing) Machine or “ARM” processors, etc. Examples of support circuitry may include various chipsets (e.g., Northbridge, Southbridge, etc. available from the Intel Corporation) configured to provide an interface through which processing module 204 may interact with other system components that may be operating at different speeds, on different buses, etc. in device 200. Some or all of the functionality commonly associated with the support circuitry may also be included in the same physical package as the processor (e.g., such as in the Sandy Bridge family of processors available from the Intel Corporation).

Processing module 204 may be configured to execute various instructions in device 200. Instructions may include program code configured to cause processing module 204 to perform activities related to reading data, writing data, processing data, formulating data, converting data, transforming data, etc. Information (e.g., instructions, data, etc.) may be stored in memory module 206. Memory module 206 may comprise random access memory (RAM) or read-only memory (ROM) in a fixed or removable format. RAM may include memory configured to hold information during the operation of device 200 such as, for example, static RAM (SRAM) or Dynamic RAM (DRAM). ROM may include memories such as Bios or Unified Extensible Firmware Interface (UEFI) memory configured to provide instructions when device 200 activates, programmable memories such as electronic programmable ROMs (EPROMS). Flash, etc. Other fixed and/or removable memory may include magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), etc. Power module 208 may include internal power sources (e.g., a battery) and/or external power sources (e.g., electromechanical or solar generator, power grid, fuel cell, etc.), and related circuitry configured to supply device 200 with the power needed to operate.

UI module 102′ may comprise equipment and/or software to facilitate user interaction with device 200. Example equipment and/or software in UI module 102′ may include, but is not limited to, input mechanisms such as microphones, switches, buttons, knobs, keyboards, speakers, touch-sensitive surfaces, at least one sensor to capture images, video and/or sense proximity, distance, motion, gestures, orientation, etc., and output mechanisms such as speakers, displays, lighted/flashing indicators, electromechanical components for vibration, motion, etc.). The equipment included in UI module 102′ may be incorporated within device 200 and/or may be coupled to device 200 via a wired or wireless communication medium.

Communication interface module 210 may be configured to manage packet routing and other control functions for communication module 212, which may include resources configured to support wired and/or wireless communications. In some instances, device 102′ may comprise more than one communication module 212 (e.g., including separate physical interface modules for wired protocols and/or wireless radios) all managed by a centralized communication interface module 210. Wired communications may include serial and parallel wired mediums such as, for example, Ethernet, Universal Serial Bus (USB), Firewire, Digital Video Interface (DVI), High-Definition Multimedia Interface (HDMI), etc. Wireless communications may include, for example, close-proximity wireless mediums (e.g., radio frequency (RF) such as based on the Near Field Communications (NFC) standard, infrared (IR), etc.), short-range wireless mediums (e.g., Bluetooth, WLAN, Wi-Fi, etc.) and long range wireless mediums (e.g., cellular wide-area radio communication technology, satellite-based communications, etc.). In one embodiment, communication interface module 210 may be configured to prevent wireless communications that are active in communication module 212 from interfering with each other. In performing this function, communication interface module 210 may schedule activities for communication module 212 based on, for example, the relative priority of messages awaiting transmission. While the embodiment disclosed in FIG. 2 illustrates communication interface module 210 being separate from communication module 212, it may also be possible for the functionality of communication interface module 210 and communication module 212 to be incorporated within the same module.

In the embodiment illustrated in FIG. 2, CT module 106′ may be able to interact with at least UI module 102′, memory module 206 and communication module 212. For example, CT module 106′ may be functionality provided by hardware (e.g., firmware) in device 200, a separate application in device 200, a plug-in to an application (e.g., an Internet browser), etc. CT module 106′ may receive original content 112 from CP 104′ via communication module 212 (e.g., via wired/wireless communication). CT module 106′ may then access UD module 108′ in memory module 206 to determine user context 114. In some cases, RB module 110′ in CT module 106′ may be requested to obtain additional information 116 to assist in determining correspondence between original content 112 and user context 114. CT module 106′ may generate augmented content 118 based on user context 114 and any additional information 116 provided by RB module 110′. Augmented content 118 may then be provided to UI module 102′, and UI module 102′ may proceed to present augmented content 118 to the user of device 200.

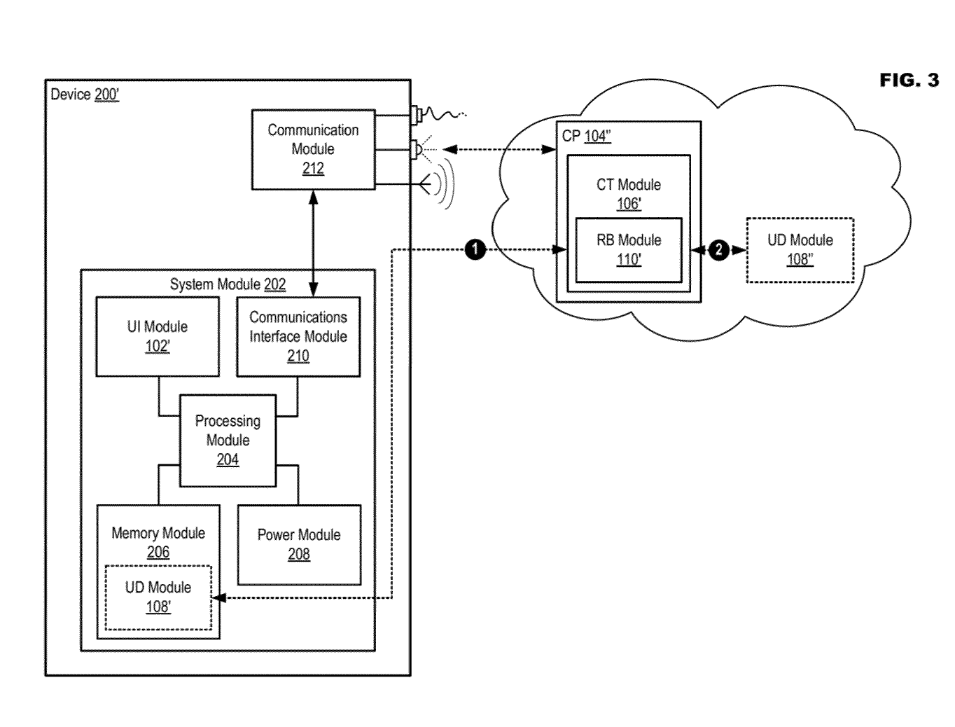

FIG. 3 illustrates an example configuration wherein a content provider performs contextual translation in accordance with at least one embodiment of the present disclosure. Modules in device 200′ that are the same as modules in device 200, as illustrated in FIG. 2, are similarly numbered. However, CT module 106′ in FIG. 3 has been relocated to CP 104″. Moving CT module 106′ out of device 200′ may allow the content translation functionality to be offloaded from device 200′. Removing the burden of content translation from device 200′ may, for example, allow embodiments of system 100 to be implemented using a variety of devices including, but not limited to, lower power/bandwidth devices like mobile devices.

CP 104″ may incorporate CT module 106, which may still require user context 114 corresponding to the current user of device 200′ prior to generating augmented content 118. In this regard, different placements for UD module 108 may be possible. UD module 108′ may still be located in memory module 206, and may provide user context 114 to CT module 106′ via communication module 212 (e.g., as shown at “1”). Alternatively. UD module 108″ may be situated outside of device 200′, such as in a computing resource accessible via a LAN or WAN such as the Internet (e.g., as shown at “2”). External UD module 108″ may have both advantages and drawbacks. At least one advantage is that external UD module 108″ is accessible to devices other than device 200′ (e.g., a user's mobile device, computing device, smart TV, etc.). However, placing UD module 108″ may also make it vulnerable to attach. Thus, the system in which UD module 108″ exists (e.g., a personal cloud storage service) must be secured against being compromised by attackers seeking unauthorized access to the users' identity information, context information, etc.

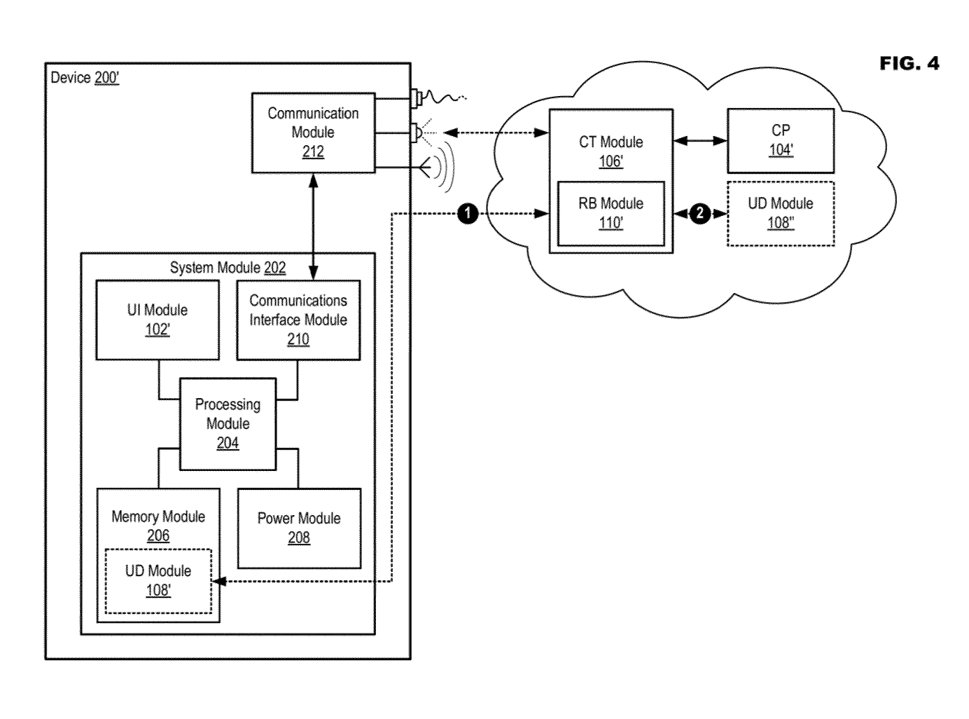

FIG. 4 illustrates an example configuration wherein a third party performs contextual translation in accordance with at least one embodiment of the present disclosure. In FIG. 4 the configuration of device 200′ is unchanged from the example illustrated FIG. 3. However, in FIG. 4 the context translation services are no longer provided by CP 104′. Instead, CT module 106′ may operate as a standalone service interposed between device 200′ and CP 104′. CT module 106′ may still receive original content 112 from CP 104′ and may generate augmented content 118 to provide to UI module 102′. In one embodiment, CT module 106′ may be maintained by a third party that may be unrelated to the current user of device 200′ or CP 104′. For example, the user of device 200′, the content creator or the content provider may contract with the third party to receive content translation services. The responsibility to maintain CT module 106′ may therefore be removed from both device 200′ and CP 104′.

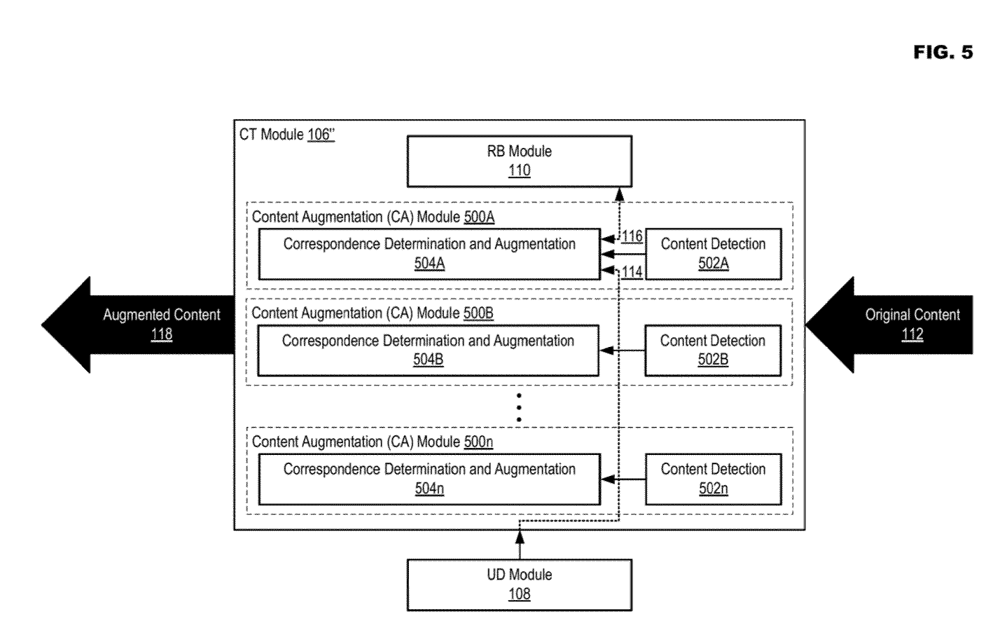

FIG. 5 illustrates an example configuration for a contextual content translation module in accordance with at least one embodiment of the present disclosure. CT module 106″ may comprise, for example, CA modules 500A, 500B . . . 500n (e.g., collectively. CA modules 500A . . . n) and RB module 110″. CA modules 500A . . . n may each be assigned to detect and augment a different characteristic from original content 112. For example, CA 500A may be assigned to augment time-related information. CA 500B may be assigned to augment language . . . CA 500n may be assigned to augment correspondence between the content and the user's relationships, etc. The number total of CA modules 500 in CT module 106′ may depend on, for example, the number of characteristics to be augmented by CT module 106″.

Each CA module 500A . . . n may include content detection functionality 502A . . . n and correspondence determination and augmentation functionality 504A . . . n, respectively. Content detection functionality 502A . . . n may search original content 112 for characteristics that need to be augmented. For example, CA module 500A may be assigned to augment time zones, and content detection functionality 502A may search for instances in original content 112 where time is mentioned. After detecting portions of original content 112 including the characteristics to be changed, correspondence determination and augmentation functionality 504A . . . n may determine correspondence between the content and the context of the user and may then make alterations to the content based on user context 114 provided by UD module 108 (e.g., as illustrated with respect to CA module 500A). In a straightforward situation like a time zone change, this may simply involve updating the time based on the user's time zone.

However, there may be instances where the correspondence between original content 112 and user context 114 are not so straightforward. For example, CA module 500A may be tasked with determining correspondence based on location, relationships, etc. To determine the correspondence, correspondence determination and augmentation functionality 504A may require additional information 116, which may be obtained through RB module 110. For example, original content 112 may include a location. Correspondence determination and augmentation functionality 504A may then determine that additional location information is required to establish correspondence between the location in the content and the user context, and may request additional location information from RB module 110. In one embodiment, RB module 110 may comprise a logic and/or knowledge-based engine that may access local and/or online resources (e.g., a contacts list, a mapping database, social networking, general online data searching, etc.) to determine whether the location is close to the user's house, the user's employment, whether the user has previously visited this location, etc. This sort of operation may also be used to determine, for example, whether the user has a connection to (e.g., is related to, has worked with, is friends with, etc.) anybody mentioned in original content 112, whether the user has a professional specialty or interest in any topics discussed in original content 112, whether the user has a historical connection to material in original content 112, etc. The correspondence determination may then be used by correspondence determination and augmentation functionality 504A . . . n to generate augmented content 118.

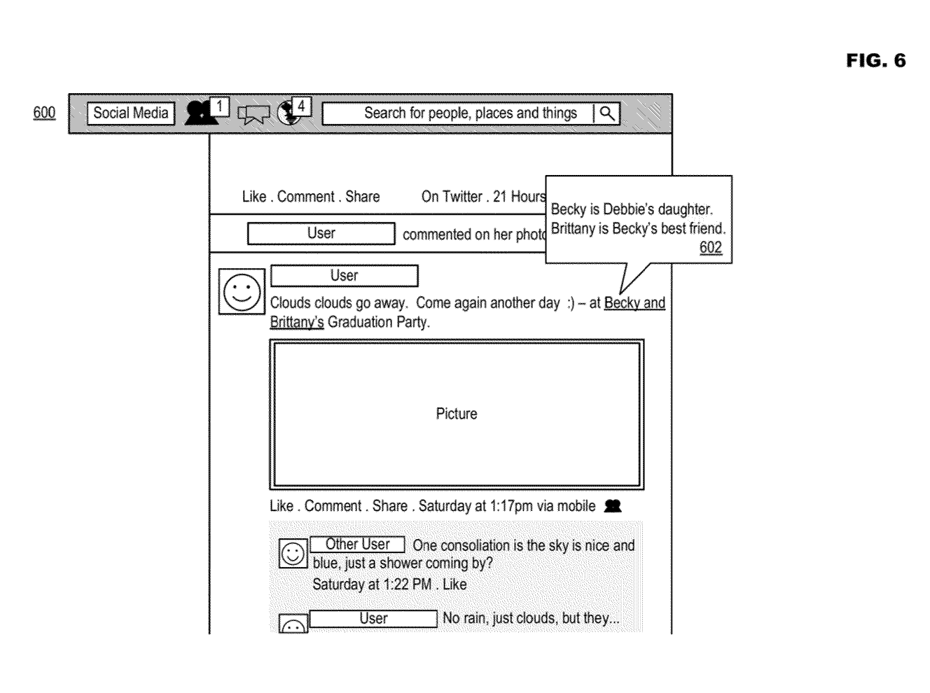

FIG. 6 illustrates a first example of contextual content translation in accordance with at least one embodiment of the present disclosure. In the example illustrated in FIG. 6, social media content 600 is augmented to illustrate a relationship between content 600 and a user viewing the presentation of content 600. Information 602 has been inserted into content 600 to describe a relationship between content 600 and the user. In particular, information 602 describes a relationship between a person mentioned in content 600 and a person with whom the user viewing the presentation of content 600 has a relationship.

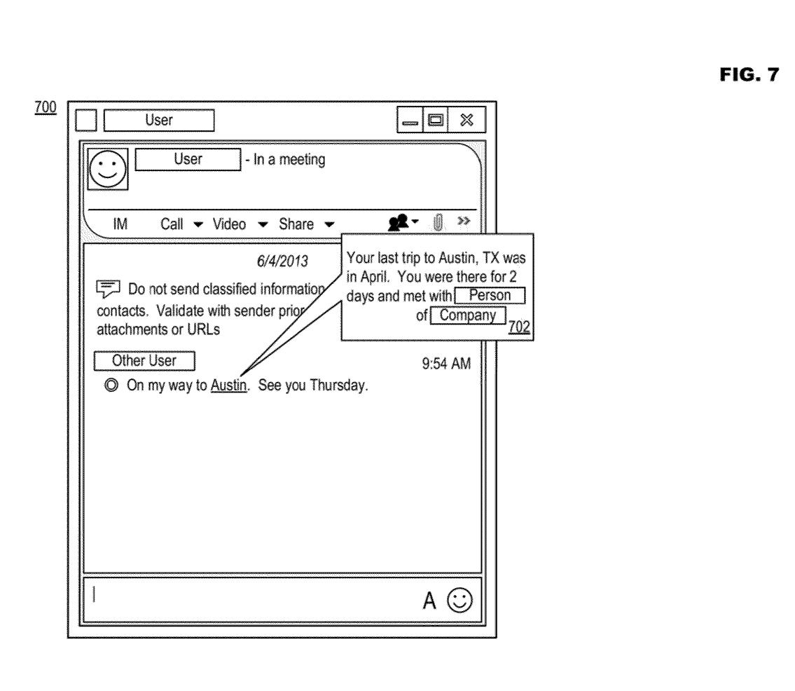

FIG. 7 illustrates a second example of contextual content translation in accordance with at least one embodiment of the present disclosure. In FIG. 7, messaging content 700 has also been augmented to include information 702 describing correspondence between content 700 and the user viewing the presentation of content 700. In this example, a location (e.g., Austin, Tex.) has been augmented to advise the user of a historical relationship. In particular, the user visited Austin last April. Information 702 may further apprise the user of more than one correspondence. In addition to the location that was visited, information 702 also includes people visited at the location, the company where the people are employed, etc.

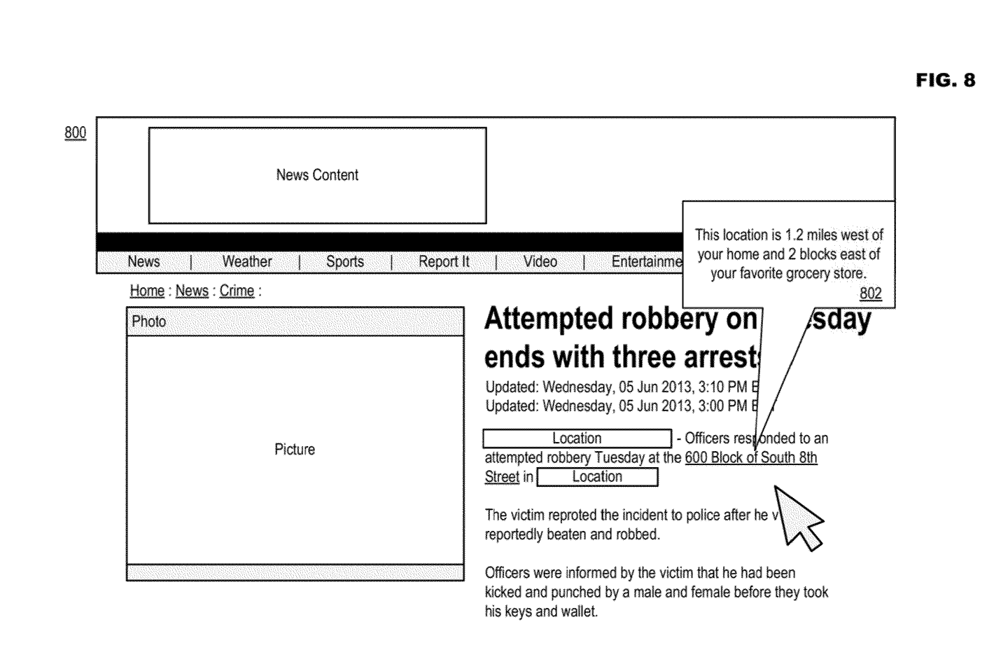

FIG. 8 illustrates a third example of contextual content translation in accordance with at least one embodiment of the present disclosure. In the example illustrated in FIG. 8, news content 800 may include information 802 highlighting a relationship between news content 800 and the user viewing the presentation of content 800. Information 802 may relate to a location discussed in news content 800, and describes the significance of the location from the context of the user (e.g., the location is 1.2 miles west of the user's home and is two blocks from the user's favorite grocery store). As news content 800 is related to a criminal event, the location of the criminal event may be of significance to the viewing user from the standpoint of safety.

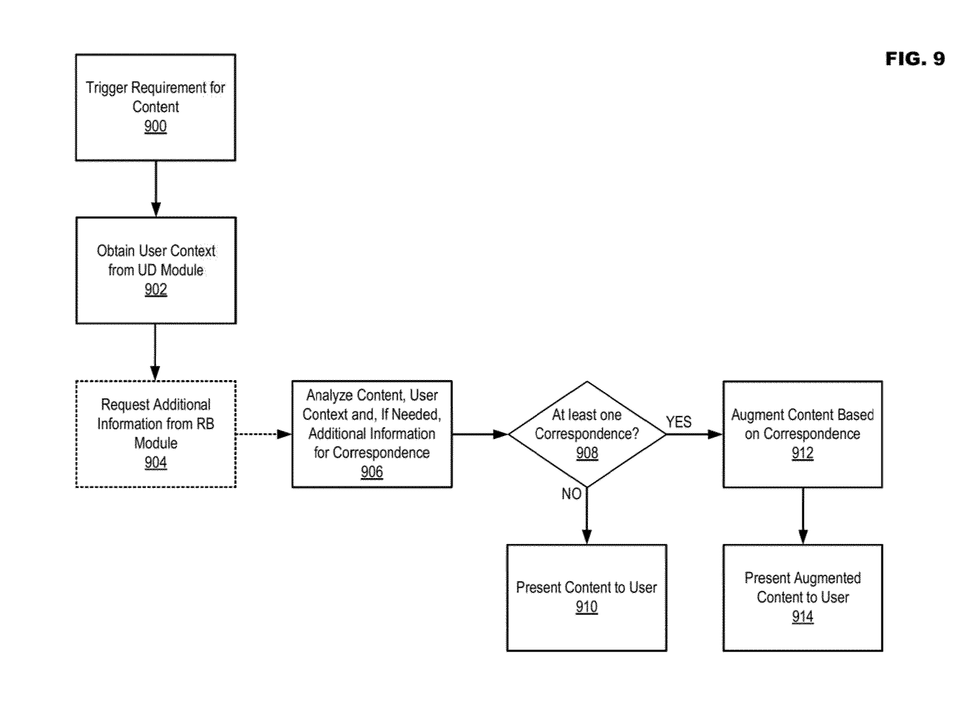

FIG. 9 illustrates example operations for a contextual content translation system in accordance with at least one embodiment of the present disclosure. Initially, in operation 900 a requirement for content may be triggered. For example, user interaction with a device (e.g., using a UI module) may cause a request to be transmitted to a content provider. In operation 902, user context may be obtained from a UD module. For example, the UD module may be situated in the device or outside the device (e.g., in a location accessible via a LAN or WAN like the Internet). Optionally, additional information for use in determining correspondence between the content and user context may be requested from an RB module in operation 904. Operation 904 may be optional in that additional information may not be required in every situation (e.g., some correspondence determinations may be readily apparent without any additional information such as time zone changes, language translation, etc.).

The content, the user context and, if necessary, the additional information may then be analyzed for any correspondence in operation 906. For example, the correspondence analysis may be performed by at least one CA module in a CT module. A determination may then be made in operation 908 as to whether at least one correspondence exists between the content and the user context. If it is determined in operation 908 that no correspondence exists, then in operation 910 the content may be presented to user (e.g., via the UI module in the device). Alternatively, if it is determined in operation 908 that at least one correspondence exists, then in operation 912 the content may be augmented based on the correspondence. For example, augmentation may include changing the content, removing a portion of the content, adding information to the content, etc. The augmented content may then be presented to the user in operation 914 (e.g., via the UI module in the device).

While FIG. 9 illustrates operations according to an embodiment, it is to be understood that not all of the operations depicted in FIG. 9 are necessary for other embodiments. Indeed, it is fully contemplated herein that in other embodiments of the present disclosure, the operations depicted in FIG. 9, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, the present disclosure is directed to contextual content translation system. A system may comprise a device to present content to a user, the content being obtained from a content provider (CS). Prior to presentation, a contextual translation (CT) module may augment the content based on the context of the user. The CT module may receive the content from the CS, may receive information about the context of the user from a user data (UD) module and may augment the content based on the user context. Additional information may be provided by a relationship builder (RB) module, as needed, to help determine the correspondence between the content and the user context. Augmenting the content may comprise altering the content (e.g., changing or removing portions of the content) or adding information to the content, the information relating to how portions of the content may correspond to the context of the user.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a contextual content translation system, as provided below.

### EXAMPLE 1

According to this example there is provided a device comprising a communication module to transmit and receive data and a user interface module to cause content to be requested from a content provider via the communication module, receive augmented content from a contextual translation module, the contextual translation module being to augment the content provided by the content provider based on a context corresponding to a device user and present the augmented content.

### EXAMPLE 2

This example includes the elements of example 1, wherein the contextual translation module is situated in the device.

### EXAMPLE 3

This example includes the elements of any of examples 1 to 2, wherein the contextual translation module is provided by the content provider.

### EXAMPLE 4

This example includes the elements of any of examples 1 to 3, wherein the contextual translation module is provided by a third party interacting with at least one of the device or the content provider.

### EXAMPLE 5

This example includes the elements of example 4, wherein the device user subscribes to a service provided by the third party to allow the device to gain access the contextual translation module.

### EXAMPLE 6

This example includes the elements of any of examples 1 to 5, wherein the context corresponding to the user comprises at least user background information, user living situation information and user relationship information.

### EXAMPLE 7

This example includes the elements of any of examples 1 to 6, wherein the contextual translation module is further to receive the context corresponding to the device user from a user data module.

### EXAMPLE 8

This example includes the elements of example 7, wherein the context corresponding to the device user is derived at least in part from social media information associated with the device user.

### EXAMPLE 9

This example includes the elements of any of examples 7 to 8, wherein the context corresponding to the device user is derived at least in part from information provided by sensors in the device.

### EXAMPLE 10

This example includes the elements of any of examples 7 to 9, wherein the user data module comprises an analytical engine to derive at least part of the context corresponding to the device user based on seed information.

### EXAMPLE 11

This example includes the elements of any of examples 7 to 10, wherein the user data module is situated in the device.

### EXAMPLE 12

This example includes the elements of any of examples 7 to 11, wherein the user data module is situated remotely from the device and is accessible via the communication module.

### EXAMPLE 13

This example includes the elements of any of examples 1 to 12, wherein the contextual translation module comprises a relationship builder module to at least obtain additional information for determining correspondence between information in the content and the context corresponding to the device user.

### EXAMPLE 14

This example includes the elements of example 13, wherein the relationship builder module comprises a knowledge-based engine to obtain the additional information from a wide area network for use in determining correspondence between the content and the context corresponding to the user.

### EXAMPLE 15

This example includes the elements of any of examples 1 to 14, wherein the contextual translation module comprises at least one content augmentation module to detect at least one characteristic of the content, determine a correspondence between the at least one characteristic in the content and at least one characteristic in the context corresponding to the device user and augment the content based on the correspondence.

### EXAMPLE 16

This example includes the elements of example 15, wherein the content augmentation module is further to request information related to the context corresponding to the device user from a user data module.

### EXAMPLE 17

This example includes the elements of any of examples 15 to 16, wherein the content augmentation module is further to request additional information for use in determining the correspondence from a relationship builder module.

### EXAMPLE 18

This example includes the elements of any of examples 15 to 17, wherein the contextual translation module comprises a plurality of content augmentation modules to detect different characteristics of the content.

### EXAMPLE 19

This example includes the elements of any of examples 15 to 18, wherein the contextual translation module being to augment the content comprises the contextual translation module being to at least one of alter the content based on the correspondence, remove a portion of the content based on the correspondence or add information regarding the correspondence to the content.

### EXAMPLE 20

This example includes the elements of example 19, wherein the contextual translation module being to add information regarding the correspondence to the content comprises the contextual translation module being to add visible indicia to the content, the visible indicia indicating the correspondence between the content and the context corresponding to the user.

### EXAMPLE 21

This example includes the elements of any of examples 1 to 20, wherein the contextual translation module is situated in the device, is provided by the content provider or is provided by a third party interacting with at least one of the device or the content provider.

### EXAMPLE 22

This example includes the elements of any of examples 1 to 21, wherein the contextual translation module is further to receive the context corresponding to the device user from a user data module.

### EXAMPLE 23

This example includes the elements of example 22, wherein the context corresponding to the device user is derived at least in part from at least one of social media information associated with the device user or information provided by sensors in the device.

### EXAMPLE 24

This example includes the elements of any of examples 22 to 23, wherein the user data module is situated in the device or remotely from the device and is accessible via the communication module.

### EXAMPLE 25

According to this example there is provided a method comprising triggering in a device a requirement for content provided by a content provider, receiving augmented content from a contextual translation module, the contextual translation module being to augment the content provided by the content provider based on a context corresponding to a device user and presenting the augmented content.

### EXAMPLE 26

This example includes the elements of example 25, and further comprises subscribing to a service provided by a third party to gain access to the contextual translation module.

### EXAMPLE 27

This example includes the elements of any of examples 25 to 26, and further comprises obtaining information from a user data module regarding the context corresponding to the device user.

### EXAMPLE 28

This example includes the elements of example 27, and further comprises deriving at least part of the context corresponding to the device user based on seed information using an analytical engine included in the user data module.

### EXAMPLE 29

This example includes the elements of any of examples 25 to 28, and further comprises requesting additional information from a relationship builder module for determining correspondence between information in the content and the context corresponding to the device user.

### EXAMPLE 30

This example includes the elements of example 29, and further comprises obtaining the additional information from a wide area network for use in determining correspondence between the content and the context corresponding to the user using a knowledge-based engine included in the relationship builder module.

### EXAMPLE 31

This example includes the elements of any of examples 25 to 30, and further comprises detecting at least one characteristic of the content, determining a correspondence between the at least one characteristic in the content and at least one characteristic in the context corresponding to the device user and augmenting the content based on the correspondence.

### EXAMPLE 32

This example includes the elements of example 31, wherein augmenting the content comprises at least one of altering the content based on the correspondence, removing a portion of the content based on the correspondence or adding information regarding the correspondence to the content.

### EXAMPLE 33

This example includes the elements of example 32, wherein adding information regarding the correspondence to the content comprises adding visible indicia to the content, the visible indicia indicating the correspondence between the content and the context corresponding to the user.

### EXAMPLE 34

This example includes the elements of any of examples 25 to 33, and further comprises obtaining information from a user data module regarding the context corresponding to the device user and requesting additional information from a relationship builder module for determining correspondence between information in the content and the context corresponding to the device user.

### EXAMPLE 35

This example includes the elements of any of examples 25 to 34, and further comprises detecting at least one characteristic of the content, determining a correspondence between the at least one characteristic in the content and at least one characteristic in the context corresponding to the device user and augmenting the content based on the correspondence.

### EXAMPLE 36

According to this example there is provided a system including at least one device, the system being arranged to perform the method of any of the above examples 25 to 35.

### EXAMPLE 37

According to this example there is provided a chipset arranged to perform the method of any of the above examples 25 to 35.

### EXAMPLE 38

According to this example there is provided at least one machine readable medium comprising a plurality of instructions that, in response to be being executed on a computing device, cause the computing device to carry out the method according to any of the above examples 25 to 35.

### EXAMPLE 39

According to this example there is provided a device configured for use with a contextual content translation system, the device being arranged to perform the method of any of the above examples 25 to 35.

### EXAMPLE 40

According to this example there is provided a device having means to perform the method of any of the examples 25 to 35.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-23. (canceled)

24. A device, comprising:
a communication module to transmit and receive data; and
a user interface module to:
cause content to be requested from a content provider via the communication module;
receive augmented content from a contextual translation module, the contextual translation module being to augment the content provided by the content provider based on a context corresponding to a device user; and
present the augmented content.

25. The device of claim 24, wherein the contextual translation module is situated in the device.

26. The device of claim 24, wherein the contextual translation module is provided by the content provider.

27. The device of claim 24, wherein the contextual translation module is provided by a third party interacting with at least one of the device or the content provider.

28. The device of claim 24, wherein the contextual translation module is further to receive the context corresponding to the device user from a user data module.

29. The device of claim 28, wherein the context corresponding to the device user is derived at least in part from social media information associated with the device user.

30. The device of claim 28, wherein the context corresponding to the device user is derived at least in part from information provided by sensors in the device.

31. The device of claim 28, wherein the user data module is situated in the device.

32. The device of claim 28, wherein the user data module is situated remotely from the device and is accessible via the communication module.

33. The device of claim 24, wherein the contextual translation module comprises a relationship builder module to at least obtain additional information for determining correspondence between information in the content and the context corresponding to the device user.

34. The device of claim 24, wherein the contextual translation module comprises at least one content augmentation module to:
detect at least one characteristic of the content;
determine a correspondence between the at least one characteristic in the content and at least one characteristic in the context corresponding to the device user; and
augment the content based on the correspondence.

35. The device of claim 34, wherein the contextual translation module comprises a plurality of content augmentation modules to detect different characteristics of the content.

36. The device of claim 34, wherein the contextual translation module being to augment the content comprises the contextual translation module being to at least one of alter the content based on the correspondence, remove a portion of the content based on the correspondence or add information regarding the correspondence to the content.

37. A method, comprising:
triggering in a device a requirement for content provided by a content provider;
receiving augmented content from a contextual translation module, the contextual translation module being to augment the content provided by the content provider based on a context corresponding to a device user; and
presenting the augmented content.

38. The method of claim 37, further comprising:
obtaining information from a user data module regarding the context corresponding to the device user.

39. The method of claim 37, further comprising:
requesting additional information from a relationship builder module for determining correspondence between information in the content and the context corresponding to the device user.

40. The method of claim 37, further comprising:
detecting at least one characteristic of the content;
determining a correspondence between the at least one characteristic in the content and at least one characteristic in the context corresponding to the device user; and
augmenting the content based on the correspondence.

41. The method of claim 40, wherein augmenting the content comprises at least one of altering the content based on the correspondence, removing a portion of the content based on the correspondence or adding information regarding the correspondence to the content.

42. At least one machine-readable storage medium having stored thereon, individually or in combination, instructions that when executed by one or more processors result in the following operations comprising:
triggering in a device a requirement for content provided by a content provider;
receiving augmented content from a contextual translation module, the contextual translation module being to augment the content provided by the content provider based on a context corresponding to a device user; and
presenting the augmented content.

43. The medium of claim 42, further comprising instructions that when executed by one or more processors result in the following operations comprising:
obtaining information from a user data module regarding the context corresponding to the device user.

44. The medium of claim 42, further comprising instructions that when executed by one or more processors result in the following operations comprising:
requesting additional information from a relationship builder module for determining correspondence between information in the content and the context corresponding to the device user.

45. The medium of claim 42, further comprising instructions that when executed by one or more processors result in the following operations comprising:
detecting at least one characteristic of the content;
determining a correspondence between the at least one characteristic in the content and at least one characteristic in the context corresponding to the device user; and
augmenting the content based on the correspondence.

46. The medium of claim 45, wherein augmenting the content comprises at least one of altering the content based on the correspondence, removing a portion of the content based on the correspondence or adding information regarding the correspondence to the content.
